(19) United States
(12) Patent Application Publication
(10) Pub. No.: US 2009/0292864 A1
(43) Pub. Date: Nov. 26, 2009

(54) IDENTIFICATION INFORMATION MANAGEMENT SYSTEM AND METHOD FOR MICROCOMPUTER

(75) Inventor: Kenji Mori, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/430,549

(22) Filed: Apr. 27, 2009

(30) Foreign Application Priority Data
May 21, 2008 (JP) 2008-132907

(51) Int. Cl. G06F 12/02; G06F 12/00

(52) U.S. Cl. 711/103; 711/E12.001; 711/E12.008

(57) ABSTRACT

An exemplary object of the present invention is to facilitate the management of identification information in a microcomputer having a flash memory. A system 1 in accordance with an example embodiment of the present invention includes flash programming section 2 that writes information including a user program to a flash memory 21, first user program transmitting section 3 that transmits the user program from the user side to the host side through the communication network 15, user program receiving section 4 that receives the user program, custom code assigning section 5 that assigns a custom code that enables the discrimination of the user program, first custom code transmitting section 6 that transmits the custom code to the flash programming section 2, and custom code storing section 7 that stores the custom code within the microcomputer 11.

### BACKGROUND

1. Field of the Invention

The present invention relates to a system and method for managing identification information of a microcomputer using a flash memory as a program memory.

2. Description of Related Art

In recent years, the use of writable flash memories, in addition to or in place of non-writable mask ROMs or the likes, as program memories used in embedded microcomputers has been increasing. In general, a seal of a code including a custom code is put on the package of a microcomputer using a mask ROM (hereinafter called “mask microcomputer”) as an identification code. This custom code is uniquely associated with incidental information such as a version of a user program written in the mask ROM, and in general, is assigned and affixed by a semiconductor manufacturer manufacturing microcomputers. A device manufacturer manufacturing certain devices having such mask microcomputers embedded therein has been conducting production control, after-shipment maintenance management, and a similar management based on these custom codes.

By contrast, with regard to a microcomputer using a flash memory (hereinafter called “flash microcomputer”), the above-described custom code is not typically assigned and affixed by the semiconductor manufacturer. This is because, in the case of a flash microcomputer, a user program is typically written by the device manufacture.

FIG. 9A is an external view of a mask microcomputer 101, and FIG. 9B shows an identification code 102 affixed on the package of this mask microcomputer 101. As shown in FIG. 9B, this identification code 102 is composed of a product name code 103 indicating the type of the product and the class of the package, and the above-described custom code 104 for discriminating user programs written in the mask ROM.

FIG. 10A is an external view of a flash microcomputer 111, and FIG. 10B shows an identification code 112 affixed on the package of this flash microcomputer 111. As described above, a user program is customarily written by a device manufacturer in the flash microcomputers 111, so that the custom code has not been written when they are shipped from the semiconductor manufacturer. Therefore, as shown in FIG. 10B, the identification code 112 is composed of a product name code 113 alone, and there is no description corresponding to the above-described custom code.

FIG. 11 shows a typical method for writing a user program to a flash microcomputer 111 in the related art. A user program is typically developed by a development department 201 of a device manufacturer or the like, copied in a medium 202, and distributed to a plurality of production factories 203. At this point, a mode setting value 205, which varies depending on the type and the operation mode (such as the interface used in a writing operation) of the flash microcomputer 111, is also distributed. In each of the production factories 203, the setting of flash programming devices 204 is adjusted based on the distributed write mode configuration information 205, and the user program distributed by the medium 202 is written to a flash memory 115 of the flash microcomputer 111.

Furthermore, Japanese Unexamined Patent Application Publication No. 2001-306543 discloses a technique relating to a method of writing a user program in a flash microcomputer. A microcomputer in accordance with the Japanese Unexamined Patent Application Publication No. 2001-306543 has a nonvolatile memory that stores either one or both of version information and lot information of the flash memory, and this nonvolatile memory has a memory area in which necessary parameters for an information writing process carried out by the CPU are stored. In this way, it is possible to select an optimal flash firmware and parameters to carry out the information writing process.

### SUMMARY

The present inventors have found a following problem. As described above, with regard to the mask microcomputer, a seal of a custom code is put on the package and used as important information in the production control and the maintenance management of the product. However, with regard to the flash microcomputer, which has been on an upward trend in recent years, no custom code has been affixed at the point when they are shipped from a semiconductor manufacturer. Therefore, a custom code needs to be individually assigned to each flash microcomputer on the device manufacturer side, and thereby posing a problem that a large burden is imposed on the device manufacturer for identification management.

Furthermore, in the technique disclosed in the above-mentioned Japanese Unexamined Patent Application Publication No. 2001-306543, either one or both of version information and lot information need to be individually stored in each microcomputer, and therefore also posing a problem relating to the above-described identification information management.

In an exemplary aspect, the present invention has been made to solve the above-described problems. A first exemplary aspect of an embodiment of the present invention is an identification information management system including: flash programming section that writes information including a user program to a flash memory to be embedded in a microcomputer; first user program transmitting section that transmits the user program written by the flash programming section to a host side through a communication network; user program receiving section that receives the user program transmitted by the first user program transmitting section through the communication network; custom code assigning section that assigns a custom code based on the user program received by the user program receiving section, the custom code enabling the identification of the user program; first custom code transmitting section that transmits the custom code assigned by the custom code assigning section to the flash programming section through the communication network; and custom code storing section that stores the custom code received by the flash programming section, the custom code storing section being embedded in the microcomputer.

In accordance with this system, a user of a device manufacturer or the like operates a certain terminal and transmits the above-mentioned user program to the host side equipped with a server system or the like through a communication network such as the Internet, so that a custom code is assigned to the user program on the host side. Then, this custom code is transmitted from the host side to the user side through the communication network, stored in a microcomputer having a flash memory, and used for the production control and the maintenance management.

Furthermore, another exemplary aspect of an embodiment of the present invention is an identification information management method including: a step for transmitting a user program to a host side through a communication network, the user program being written in a flash memory to be embedded in a microcomputer by a flash programming device; a step for receiving the user program transmitted from the user side through the communication network; a step for assigning a custom code identifying the received user program based on that user program; a step for transmitting the custom code to the user side through the communication network; and a step for receiving the custom code transmitted from the host side and storing the received custom code within the microcomputer.

This method has similar advantageous effects to those of the above-described system.

In accordance with an exemplary aspect of the present invention, a process such as assigning a custom code is carried out by a system on the host side, and a user side (such as a device manufacturer) can acquire the custom code from the system on the host side through the Internet or the like and store this acquired custom code in a memory of a flash microcomputer. In this way, the burden in the identification management imposed on the user side can be alleviated.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 shows a basic configuration of an identification information management system in accordance with an aspect of the present invention;

FIG. 2 is a conceptual diagram illustrating an overall hardware configuration of an identification information management system in accordance with an exemplary embodiment of the present invention;

FIG. 3 shows a configuration of a flash microcomputer in accordance with an exemplary embodiment of the present invention;

FIG. 4 shows a configuration of a flash programming device in accordance with an exemplary embodiment of the present invention;

FIG. 5 shows a configuration of a user terminal in accordance with an exemplary embodiment of the present invention;

FIG. 6 shows a configuration of a management server in accordance with an exemplary embodiment of the present invention;

FIG. 7 is a flowchart illustrating a process flow when a custom code is assigned in an identification information management system in accordance with an exemplary embodiment of the present invention;

FIG. 8 is a flowchart illustrating a process flow when writing is carried out on a flash memory in an identification information management system in accordance with an exemplary embodiment of the present invention;

FIG. 9A shows a state of the package of a mask microcomputer in the related art;

FIG. 9B shows a structure of an identification code affixed on the package;

FIG. 10A shows a state of the package of a flash microcomputer in the related art;

FIG. 10B shows a structure of an identification code affixed on the package; and

FIG. 11 shows a method of writing a user program to a flash microcomputer in the related art.

### DETAILED DESCRIPTION OF THE EXEMPLARY EMBODIMENTS

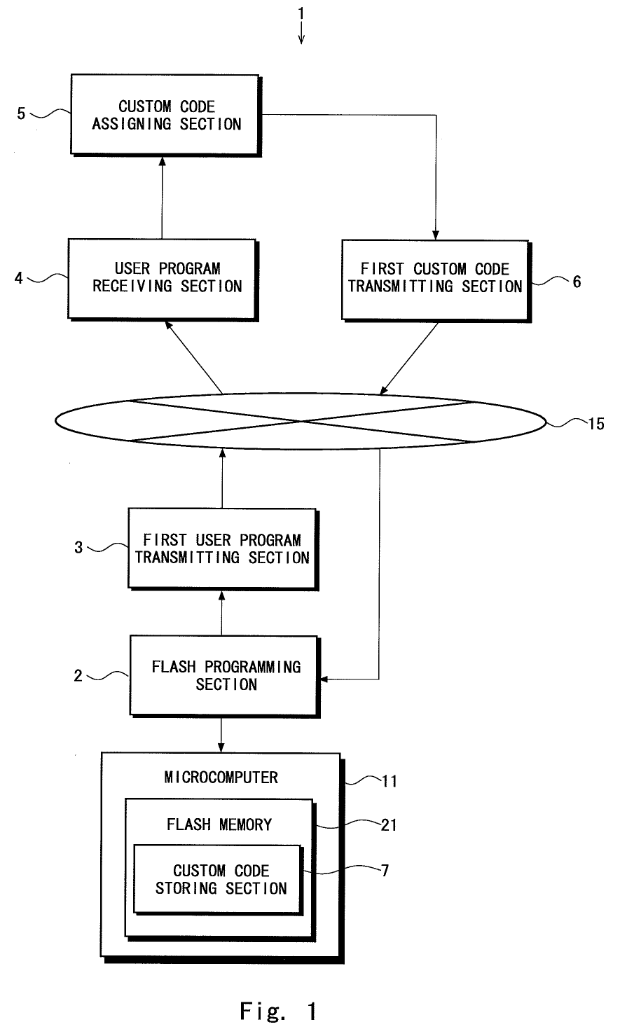

Exemplary embodiments of the present invention are explained hereinafter with reference to the attached drawings. FIG. 1 is a block diagram illustrating a basic configuration of an identification information management system 1 in accordance with an exemplary aspect of the present invention. This identification information management system 1 includes flash programming section 2, user-side user program transmitting section 3, host-side user program receiving section 4, custom code assigning section 5, host-side custom code transmitting section 6, and custom code storing section 7.

The flash programming section 2 writes information including a user program to a flash memory 21 to be embedded in a microcomputer 11.

The user-side user program transmitting section 3 transmits the user program written by the flash programming section 2 from the user side to the host side through a communication network 15.

The host-side user program receiving section 4 receives the user program transmitted by the user-side user program transmitting section 3 through the communication network 15.

The custom code assigning section 5 assigns a custom code, which enables the identification of the user program, based on the information about the user program received by the host-side user program receiving section 4.

The host-side custom code transmitting section 6 transmits the custom code assigned by the custom code assigning section 5 to the flash programming section 2 through the communication network 15.

The custom code storing section 7 stores the custom code received by the flash programming section 2 within the microcomputer 11.

With the above-described configuration, a user operates a certain terminal and transmits a user program to the host side equipped with a server system or the like through the communication network 15, so that a custom code is assigned to the user program on the host side. Then, this custom code is transmitted from the host side to the user side through the communication network 15, stored within the microcomputer 11 having a flash memory 21, and used for production control and maintenance management.

A specific example configured to realize the present invention is explained hereinafter.

### First Exemplary Embodiment

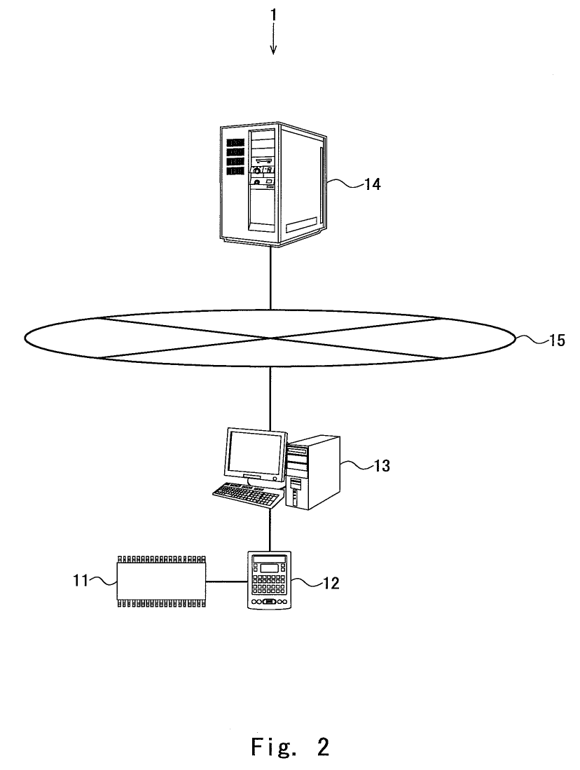

FIG. 2 shows an example of a specific hardware configuration to realize the above-described identification information management system 1 in accordance with an exemplary aspect of the present invention. This identification information management system 1 includes a flash microcomputer 11, a flash programming device 12, a user terminal 13, a management server 14, and a communication network 15. The communication network 15 is a given information communication network configured with the Internet or the like. This communication network 15 is connected to the user terminal 13 and the management server 14. The user terminal 13 is configured such that the flash programming device 12 can connect to the user terminal 13. This flash programming device 12 may be a well-known device that can write (and rewrite) information within the microcomputer 11.

FIG. 3 shows a configuration of the microcomputer 11. This microcomputer 11 includes a flash memory 21 as a user program memory, and further includes an interface section 22, an encrypting/decrypting section 23, a flash write control section 24, and a custom code read control section 25.

The flash memory 21 may be a well-known semiconductor memory to which information can be written, and this information writing operation is made possible by the flash programming device 12. In the storage area of the flash memory 21 in accordance with this exemplary embodiment of the present invention, a user program storage section 26, a custom code storage section 27, and a security code storage section 28 are allocated. The user program storage section 26 is an area in which a given user program is stored. The custom code storage section 27 is an area in which a custom code for identifying the user program is stored. The security code storage section 28 is an area in which a security code that is set to permit information reading from the custom code storage section is stored. Only when the authentication of this security code is succeeded, the reading of the custom code and the writing of the user program are enabled.

The interface section 22 is configured by the cooperation of an I/O port, a CPU, a storage device including the flash memory 21 (and a ROM, a RAM, and the like (not shown)), and a certain program or the like stored in this storage device. The interface section 22 connects to the flash programming device 12, and thus enabling transmission/reception of information between them.

The encrypting/decrypting section 23 is configured by the cooperation of a CPU, a storage device, and a certain program or the like. The encrypting/decrypting section 23 decrypts a signal input from the interface section 22 and outputs the decrypted signal to a flash write control section 24 (which is explained later), and encrypts a signal input from the flash write control section 24 and outputs the encrypted signal to the interface section 22.

The flash write control section 24 is configured by the cooperation of a CPU, a storage device, and a certain program or the like. The flash write control section 24 performs a process to write information in the flash memory 21 based on a signal input from the encrypting/decrypting section 23, i.e., a command and write information from the flash programming device 12.

The custom code read control section 25 is configured by the cooperation of a CPU, a storage device, and a certain program or the like. The custom code read control section 25 reads information from the custom code storage section 27 allocated in the storage area of the flash memory 21, and outputs the information to the flash programming device 12 through the interface section 22. Upon receiving a custom code read command from the flash programming device 12, the custom code read control section 25 reads the custom code from the custom code storage section 27 and transmits the custom code to the flash programming device 12. The flash programming device 12 displays the received custom code on a predefined display portion (e.g., its own display or the display of the user terminal 13). Furthermore, when the setting by the security code stored in the security code storage section 28 is in the read protection state, the custom code read control section 25 prohibits the reading of the custom code.

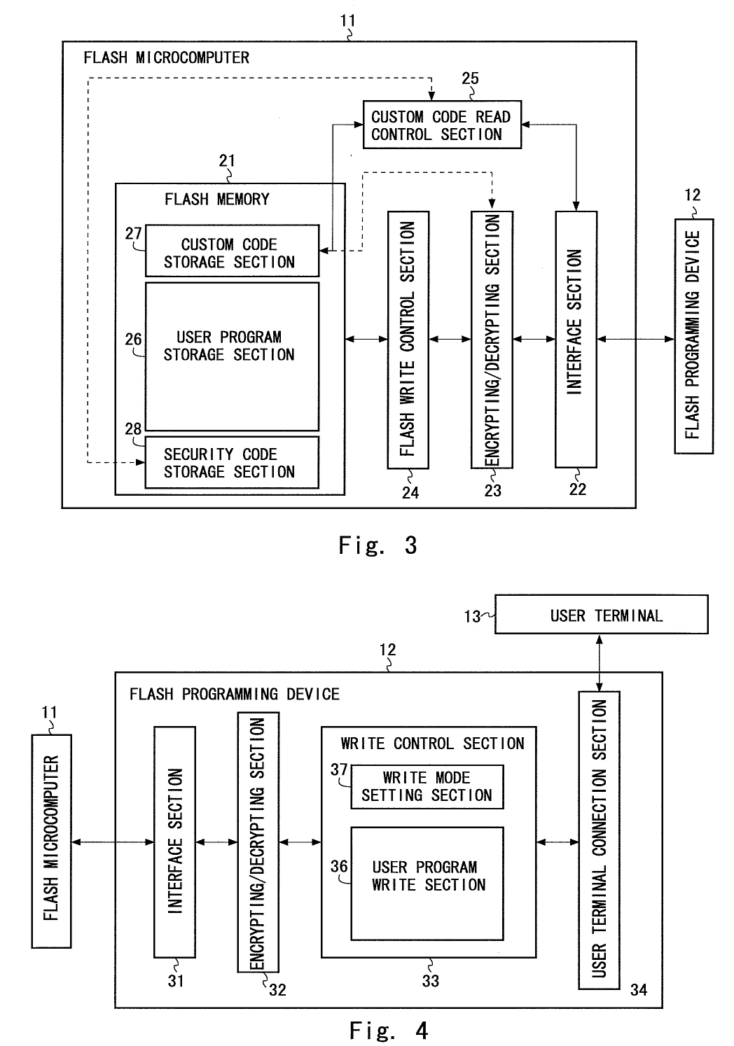

FIG. 4 shows a configuration of the flash programming device 12. This flash programming device 12 enables information writing in the flash memory 21, and includes an interface section 31, an encrypting/decrypting section 32, a write control section 33, and a user terminal connection section 34.

The interface section 31 is configured by the cooperation of an I/O port, a CPU, and a storage device (a ROM, a RAM, and the like), and a certain program or the like stored in this storage device. The interface section 31 connects to the interface section 22 of the microcomputer 11, and thus enabling signal transmission/reception between them.

The encrypting/decrypting section 32 is configured by the cooperation of a CPU, a storage device, and a certain program or the like. The encrypting/decrypting section 32 decrypts a signal input from the interface section 31 and outputs the decrypted signal to the write control section 33 (which is explained later), and encrypts a signal input from the write control section 33 and outputs the encrypted signal to the interface section 31.

The write control section 33 is configured by the cooperation of a CPU, a storage device, and a certain program or the like. The write control section 33 transmits a command and write information to the flash write control section 24 of the microcomputer 11 through the encrypting/decrypting section 32 and the interface section 31, and thereby enabling information writing in the flash memory 21. This write control section 33 includes a user program writing section 36 and a write mode setting section 37. The user program writing section 36 performs a process to write a user program in the user program storage section 26. The write mode setting section 37 defines the type, the communication speed, and the like of the interface used for the communication with the microcomputer 11. Information about a user program and a write mode handled in the write control section 33 is received from the user terminal 13 (which is explained later) through the user terminal connection section 34.

The user terminal connection section 34 is configured by the cooperation of an I/O port, a CPU, a storage device, and a certain program or the like. The user terminal connection section 34 connects to the user terminal 13 (which is explained later), and thus enabling signal transmission/reception between them.

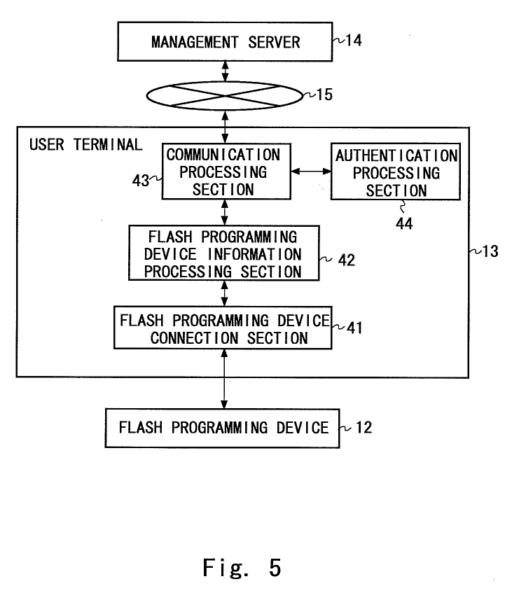

FIG. 5 shows a configuration of the user terminal 13. This user terminal 13 includes a flash programming device connection section 41, a flash programming device information processing section 42, a communication processing section 43, and an authentication processing section 44. A typical configuration of the user terminal 13 may be a personal computer having a certain program installed therein.

The flash programming device connection section 41 is configured by the cooperation of an I/O port, a CPU, a storage device, and a certain program or the like. The flash programming device connection section 41 connects to the flash programming device 12, and thus enabling signal transmission/reception between them.

The flash programming device information processing section 42 is configured by the cooperation of a CPU, a storage device, and a certain program or the like. The flash programming device information processing section 42 performs processes to create information to be used in the flash programming device 12, to process the information, and to transmit/receive the information. The information handled in the flash programming device information processing section 42 is information transmitted from the flash programming device 12 and information received from the management server 14 (which is explained later) through the communication network 15 and the communication processing section 43.

The communication processing section 43 is configured by the cooperation of a modem, a CPU, a storage device, and a certain program or the like. The communication processing section 43 enables transmission/reception of information with the management server 14 (which is explained later) through the communication network 15.

The authentication processing section 44 is configured by the cooperation of a CPU, a storage device, and a certain program or the like. The authentication processing section 44 enables the formation of a cipher communication path such as VPN between the user terminal 13 and the management server 14.

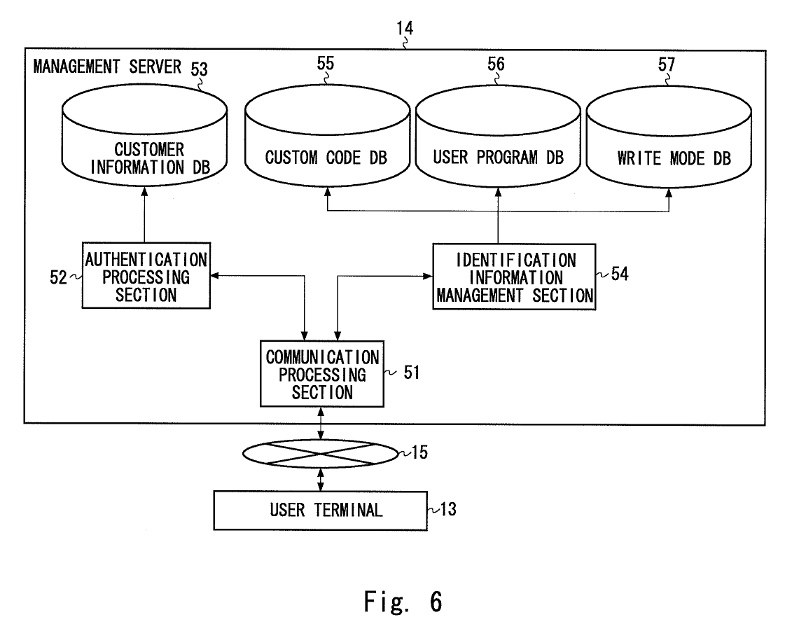

FIG. 6 shows a configuration of the management server 14. This management server 14 includes a communication processing section 51, an authentication processing section 52, a customer information database 53, an identification information management section 54, a custom code database 55, a user program database 56, and a write mode database 57.

The communication processing section 51 is configured by the cooperation of a modem, a CPU, a storage device, and a certain program or the like. The communication processing section 51 enables transmission/reception of information with the user terminal 13 through the communication network 15.

The authentication processing section 52 is configured by the cooperation of a CPU, a storage device, and a certain program or the like. The authentication processing section 52 enables the formation of a cipher communication path such as VPN between the management server 14 and the user terminal 13.

The customer information database 53 is configured by the cooperation of a CPU, a storage device, and a certain program or the like. The customer information database 53 stores necessary information for the authentication for the user terminal 13 by the authentication processing section 52.

The identification information management section 54 is configured by the cooperation of a CPU, a storage device, and a certain program or the like. The identification information management section 54 manages the identification information of the microcomputer 11. This identification information management section 54 manages the identification information with regard to the microcomputer 11 based on information stored in the custom code database 55, the user program database 56, and the write mode database 57 (all of which are explained later).

Each of these custom code database 55, user program database 56, and write mode database 57 is configured by the cooperation of a CPU, a storage device, and a certain program or the like. The custom code database 55, user program database 56, and write mode database 57 store the custom code, the user program, and the write mode setting value, respectively. Furthermore, the custom code, the user program, and the write mode setting value are stored in such a manner that they are uniquely associated with one another.

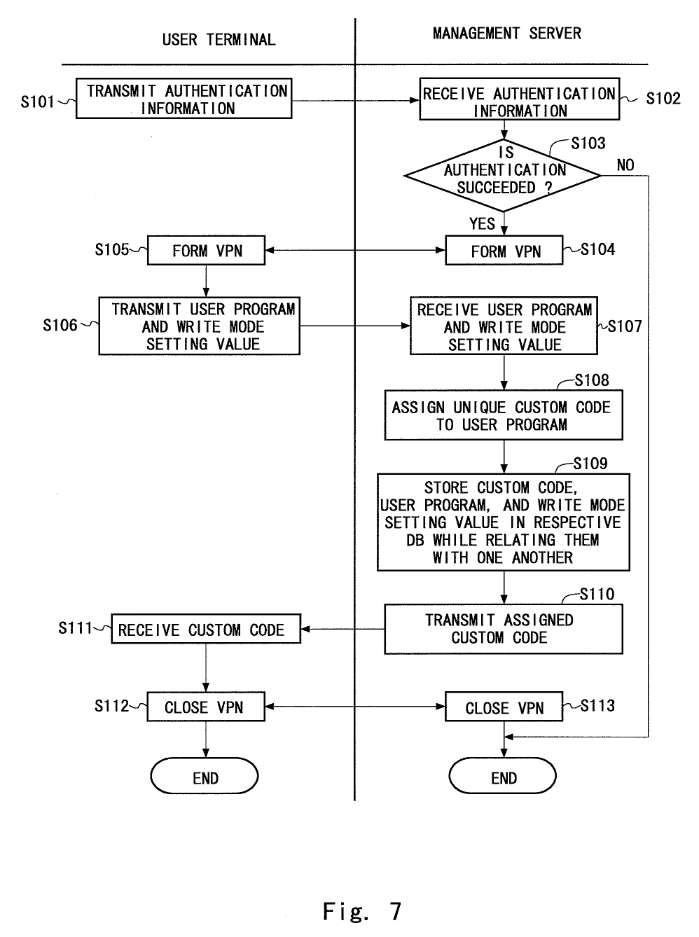

FIG. 7 shows a process flow when a custom code is assigned by the above-described identification information management system 1. Firstly, authentication information such as an ID code and a password is transmitted from the user terminal 13 (S101). When the management server 14 receives this information (S102), the decision whether the authentication is succeeded or not is made (S103). When the authentication is failed (N), this routine is terminated. When the authentication is succeeded (Y), a VPN connection is formed between the management server 14 and the user terminal 13 (S104, S105).

Next, the user terminal 13 transmits a user program that is to be written to the flash memory 21 of the microcomputer 11 by the user terminal 13 and a write mode setting value (S106). When the management server 14 receives these data (S107), the identification information management section 54 assigns a unique custom code to this user program (S108), and stores the custom code, the user program, and the write mode setting value in the respective databases 55, 56, and 57 in such a manner that they are associated with one another (S109).

After that, the management server 14 transmits the assigned custom code (S110). When the management server 14 receives the custom code (S11), the VPN connection formed between the user terminal 13 and the management server 14 is closed (S112, S113), and this routine is terminated.

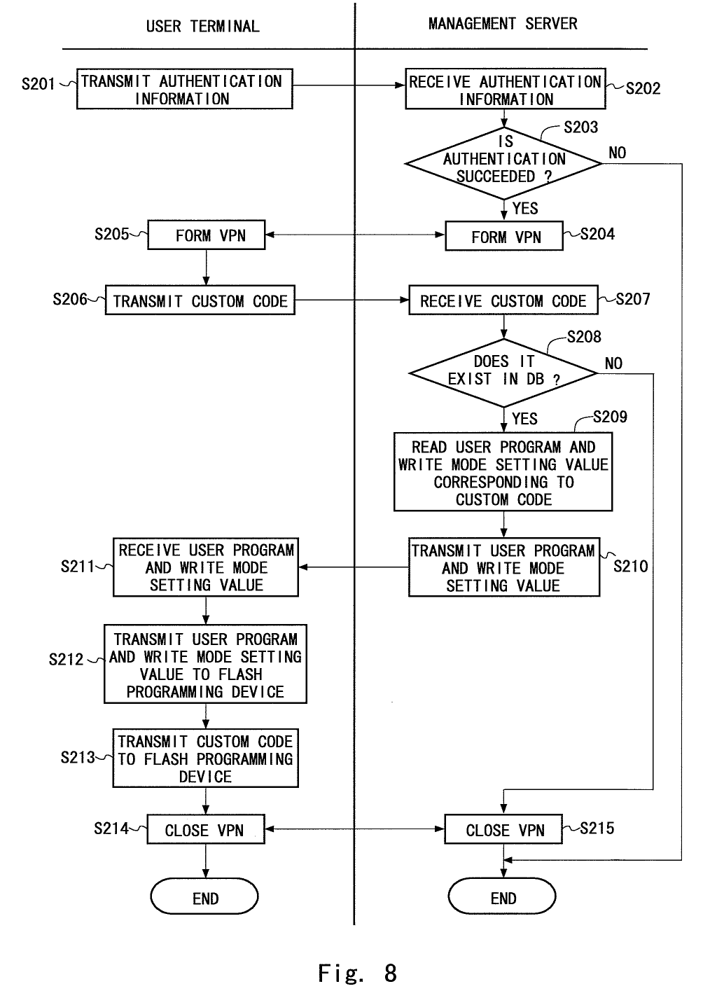

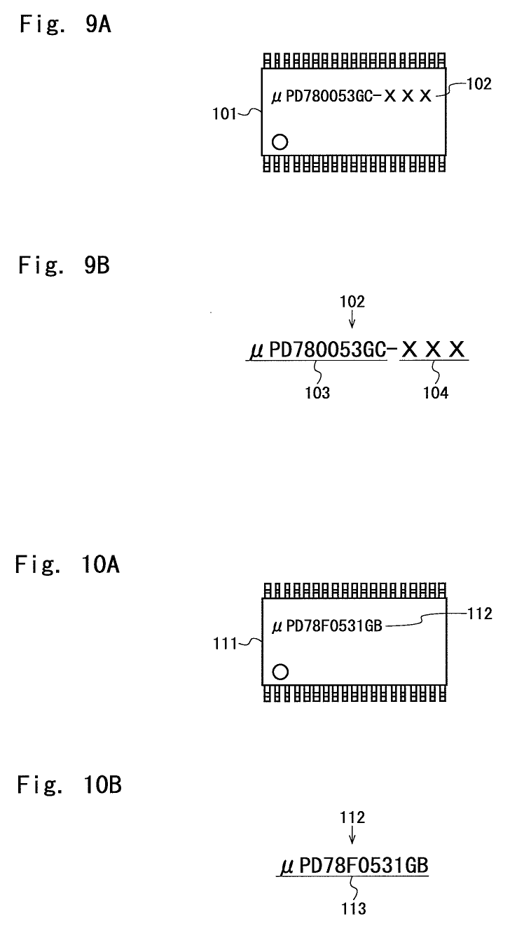

FIG. 8 is a flowchart illustrating a process flow when writing is carried out on a flash memory in the above-described identification information management system 1. Firstly, authentication information such as an ID and a password is transmitted from the user terminal 13 (S201). When the management server 14 receives this information (S202), the decision whether the authentication is succeeded or not is made (S203). When the authentication is failed (N), this routine is terminated. When the authentication is succeeded (Y), a VPN connection is formed between the management server 14 and the user terminal 13 (S204, S305).

Next, the user terminal 13 transmits the custom code (S206). When the management server 14 receives the custom code (S207) the identification information management section 54 determines whether this custom code exists in the custom code database 55 or not (S208). When it is determined that the custom code does not exist (N), after the VPN connection is closed (S214, S215), this routine is terminated. When it is determined that the custom code exists (Y), the identification information management section 54 reads a user program and a write mode setting value corresponding to this custom code from the respective databases 56 and 57 (S209).

After that, the management server 14 (the identification information management section 54) transmits the read user program and the write mode setting value (S210). When the user terminal 13 receives these data (S211), the user terminal 13 transmits the user program and the write mode setting value to the flash programming device 12 connected to the user terminal 13 (S212), and also transmits the custom code (S213). Then, the VPN connection formed between the user terminal 13 and the management server 14 is closed (S214, S215), and this routine is terminated.

In accordance with the process shown in FIG. 7, when a user who is attempting to write a certain user program to the flash memory 21 transmits information with regard to the user program by the user terminal 13, a custom code is assigned to this user program by the management server 14, and this custom code is transmitted to the user terminal 13.

Furthermore, in accordance with the process shown in FIG. 8, by entering a custom code into the user terminal 13 and transmitting it to the management server 14, a user program and a write mode setting value corresponding to this custom code are transmitted from the management server 14 to the user terminal 13. Then, the received user program and the write mode setting value are transmitted to the flash programming device 12 connected to the user terminal 13, so that the user program can be written to the flash memory 21 by using this flash programming device 12.

In this way, a user can procure a custom code for a user program, which is supposed to be written to the flash memory 21, through the communication network 15 such as the Internet, and use the procured custom code for the production control and the maintenance management.

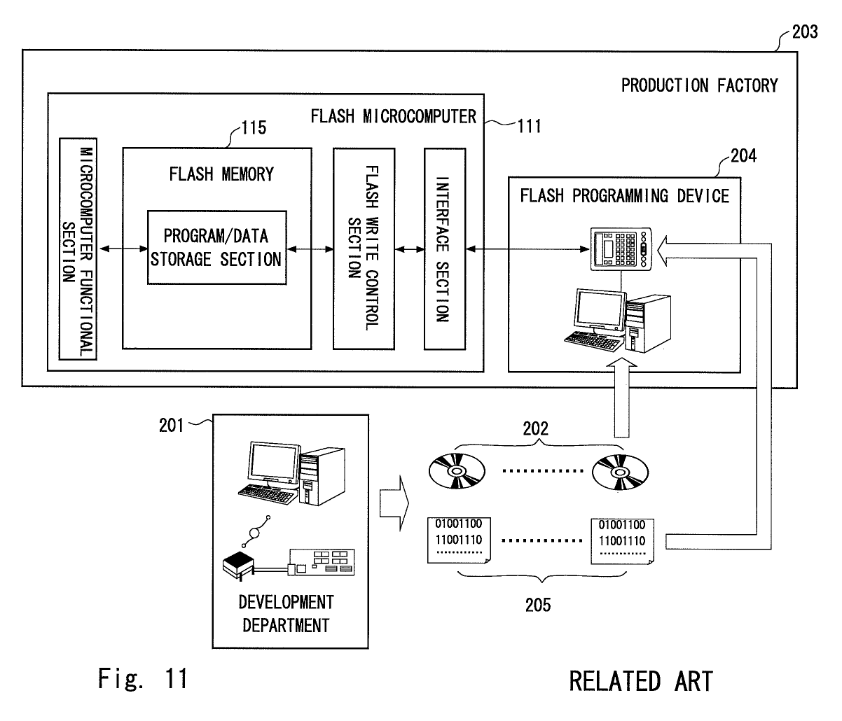

Furthermore, since users no longer needs to carry out the procedure shown in FIG. 11 in which information such as a user program and a write mode setting value is copied to a medium such as a CD-ROM and distributed, they no longer need to be worried about information leaks.

Note that although the flash programming device 12 is connected to the user terminal 13 so that information can be transmitted/received between them in the above-described exemplary embodiment, this configuration is merely an example of the present invention. In another exemplary aspect of the present invention, it can be configured in such a manner that the function of the above-described user terminal 13 is embedded, for example, in the flash programming device 12, and the flash programming device 12 is directly connected to the communication network 15.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An identification information management system comprising:
flash programming section that writes information including a user program to a flash memory to be embedded in a microcomputer;
first user program transmitting section that transmits the user program written by the flash programming section to a host side through a communication network;
user program receiving section that receives the user program transmitted by the first user program transmitting section through the communication network;
custom code assigning section that assigns a custom code based on the user program received by the user program receiving section, the custom code enabling the identification of the user program;
first custom code transmitting section that transmits the custom code assigned by the custom code assigning section to the flash programming section through the communication network; and
custom code storing section that stores the custom code received by the flash programming section, the custom code storing section being embedded in the microcomputer.

2. The identification information management system according to claim 1, further comprising:
second custom code transmitting section that transmits the custom code from the user side;
custom code receiving section that receives the custom code transmitted by the second custom code transmitting section; and
second user program transmitting section that transmits the user program corresponding to the custom code received by the custom code receiving section based on that custom code.

3. The identification information management system according to claim 2, further comprising:
write mode transmitting section that transmits a write mode setting value to the host side, the write mode setting value being configuration information to optimize the write process of the user program to the flash memory;
write mode storing section that stores a plurality of write mode setting values received from the write mode transmitting section in such a manner that the write mode setting values are associated with corresponding user programs and custom codes; and
host-side write mode transmitting section that selects the write mode setting value corresponding to the custom code received by the custom code receiving section based on that custom code and transmits the selected write mode setting value to the user side.

4. An identification information management method comprising:
a step for transmitting a user program to a host side through a communication network, the user program being written in a flash memory to be embedded in a microcomputer by a flash programming device;
a step for receiving the user program transmitted from the user side through the communication network;
a step for assigning a custom code identifying the received user program based on that user program
a step for transmitting the custom code to the user side through the communication network; and
a step for receiving the custom code transmitted from the host side and storing the received custom code within the microcomputer.

5. The identification information management method according to claim 4, further comprising:
a step for transmitting the custom code to the host side;
a step for receiving the custom code; and
a step for transmitting the user program corresponding to the custom code received by the host side based on that custom code.

6. The identification information management method according to claim 5, further comprising:
a step for transmitting a write mode setting value from the user side to the host side, the write mode setting value being configuration information to optimize the write process of the user program to the flash memory;
a step for receiving the write mode setting value transmitted from the user side on the host side and storing the write mode setting value in such a manner that the write mode setting value is associated with the corresponding user program and custom code; and
a step for transmitting the write mode setting value corresponding to the received custom code to the user side.
